(19) United States
(12) Patent Application Publication
(10) Pub. No.: US 2021/0178939 A1
(43) Pub. Date: Jun. 17, 2021

(54) Foldable Car Seat

(71) Applicant: Robert Johnson, Union, NJ (US)

(72) Inventor: Robert Johnson, Union, NJ (US)

(21) Appl. No.: 17/189,188

(22) Filed: Mar. 1, 2021

Related U.S. Application Data
(63) Continuation-in-part of application No. 16/452,449, filed on Jun. 25, 2019.
(60) Provisional application No. 62/689,411, filed on Jun. 25, 2018.

(51) Int. Cl. B60N 2/28; B60N 2/32

(52) U.S. Cl. CPC B60N 2/2866; B60N 2/32; B60N 2/2812

(57) ABSTRACT

Transporting children of differing sizes can be costly since several seat configurations are required. Installing different seat configurations can be time-consuming, too. The invention comprises a foldable automobile seat that can be used to accommodate infants, toddlers, and bigger children, with a relocatable strap that can restrain the children.

### CROSS-REFERENCE TO RELATED APPLICATIONS

This application claims priority to U.S. Non-provisional application Ser. No. 16/452,449, filed on Jun. 25, 2019, which claims priority from U.S. Provisional Application Ser. No. 62/689,411 filed on Jun. 25, 2018, both of which are entirely incorporated by this reference.

### FIELD

The present teachings relate to a foldable automobile seat that can accommodate children of different sizes.

### SUMMARY

Children of different sizes need different car seats. Infants, toddlers, and bigger children all have different car seat needs.

As a child grows, the need to buy different car seats can become quite costly. And removing an old seat and installing a new one as a child grows is time-consuming and inconvenient.

The present teachings include an automobile seat with a car seat portion, a seat belt, a back portion, and a bottom portion. The secondary car-seat portion is foldable from the back portion to reveal a child seat.

The secondary car-seat portion suitable for a toddler can be deployed from the back portion of the automobile seat to reveal a front-facing position. In this position, the contact region, i.e., the part of the secondary car-seat portion in contact with the toddler or the toddler's back, is positioned so that the toddler is facing the front of the car. The secondary car-seat portion suitable for an infant has a rear-facing position. In this configuration, the contact region is positioned so that the infant faces the rear of the car. The back surface of the secondary car-seat portion suitable for an infant (in the rear-facing position) must be high enough for the infant's head to rest on the back surface in the rear-facing position. The distance between this back surface and the back portion should be sufficient for the infant to sit comfortably and be able to stretch their legs and arms. The width of this back surface should be greater than the width of the infant. The booster position, suitable for bigger children, also has a contact region that positions the child to face the front of the car.

For the car seat portions suitable for an infant and toddler (in the rear-facing position and front-facing position, respectively), a strap restrains the child's shoulders and pelvis. For the secondary car-seat portion suitable for a bigger child (in the booster position), a seat belt serves as the restraint in some versions. Because the seat configuration for the infant (rear-facing position) and toddler (front-facing position) differs, the strap is relocatable; it moves based on the seat configuration.

In the booster position, the child seat boosts the child higher. In some examples, the child's larger size combined with the vertically upward boost allows for the seat belt to safely restrain the larger child.

When in the stowed position, the secondary car-seat portion is pulled up and returned to the back portion. The seat bottom of the secondary car-seat portion is always in contact with the bottom portion of the automobile seat, regardless of whether the secondary car-seat portion is in the front-facing position, rear-facing position, or booster position.

In some examples, the child car seat does not have a lap bar, contracting piston, or padded bar restraint.

In another embodiment, when the secondary car-seat portion is deployed to reveal the forward-facing position, the part of the secondary car-seat portion that is parallel to the bottom portion of the automobile seat can be pulled or folded out to configure the rear-facing position. The automobile seat can be retrofitted into a vehicle or used as a standalone and placed on a conventional car seat in another embodiment. The option also exists for the secondary car-seat portion suitable for an infant (the rear-facing configuration) to be pulled out from the bottom portion of the automobile seat. Pushing the rear-facing car-seat portion down into the automobile seat's bottom portion stows.

In yet another embodiment, remote control functionality allows the secondary car-seat portion to be deployed automatically. Also, the automobile seat can be heated or cooled for the child's comfort.

This disclosure covers an automobile seat having a bottom portion, a back portion, a seat belt, and a secondary car-seat portion having a back. The car-seat portion is foldable among a user rear-facing position, a user front-facing position, a user booster position, and a stowed position. In some versions, the secondary car-seat portion sits inside the automobile seat in the stowed position.

The rear-facing position orients the user-contact region toward a car's back end. The booster position orients the user-contact region toward a car front end. And the front-facing position orients the user-contact region toward a car front end, as well.

Some versions use a shoulder- or pelvis-restraining strap, which is sometimes adjustable to a user size. In these or other versions, the car-seat portion sits inside a front-facing portion of the back portion when stowed. And in some versions, when the secondary car-seat portion is in either of the rear-facing position, the front-facing position, or the booster position, the car-seat portion presses into the automobile seat bottom portion.

In some versions, the secondary car-seat portion doesn't have a lap bar, a contracting piston, a padded bar restraint, or a slide assembly. This portion can store inside the back portion of the automobile seat or sit within the automobile seat.

The booster position way orient the seat belt to restrain the user.

In some versions, the car-seat portion folds forward out of the back portion. In these or other versions, the car-seat portion connects to the automobile seat between a bottom edge of the back portion and an edge of the car seat bottom.

### BRIEF DESCRIPTION OF THE DRAWINGS

Those of skill in the art will understand that the drawings described below are only for illustrative purposes. The drawings are not intended to limit the scope of the present teachings in any way.

FIGS. 1A-B are a side perspective view of an automobile seat with a secondary car-seat portion in the rear-facing position and a front perspective view of an automobile seat with a secondary car-seat portion in the front-facing position, with an infant in a rear-facing position (1A) and a toddler in a front-facing position (1B) with a strap restraining them at their shoulders and pelvis.

FIG. 2 is a perspective view of an automobile seat with a secondary car-seat portion in a stowed position.

FIG. 3 is a perspective view of an automobile seat with a secondary car-seat portion deployed in a front-facing position, with a strap restraining the shoulders and pelvis and a seat belt present.

FIG. 4 is a perspective side view of an automobile seat with a secondary car-seat portion in a rear-facing position showing a strap that restrains the shoulders and pelvis.

FIG. 5 is a perspective front view of an automobile seat with a secondary car-seat portion in a booster position, with a seat belt restraining a larger child.

### DETAILED DESCRIPTION

Many aspects of the invention can be better understood with the references made to the drawings below. The components in the drawings are not necessarily drawn to scale. Instead, emphasis is placed on clearly illustrating the components of the present invention. Moreover, like reference numerals designate corresponding parts through the several views of the drawings.

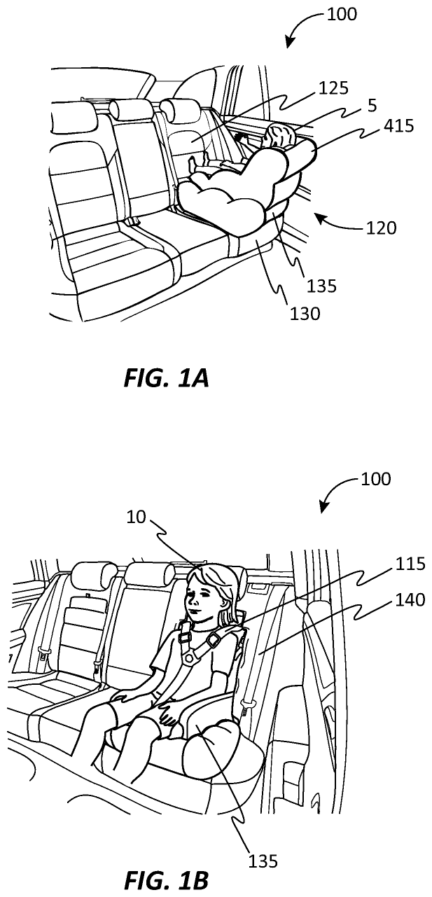

FIG. 1A-B shows an automobile seat 100 with a secondary car-seat portion 120 in the rear-facing position (1A) and front-facing position (1B). The infant 5 in FIG. 1A is facing toward the rear of the vehicle. In FIG. 1B, the secondary car-seat portion 120 is in the front-facing position, with the toddler 10 facing toward the front of the vehicle. A shoulder- or pelvis-restraining strap 115 restrains the toddler's shoulders and pelvis. The secondary car-seat portion 120 is deployed from the back portion 125 of the automobile seat. The bottom portion 130 of the automobile seat 100 is in contact with the car seat bottom 135.

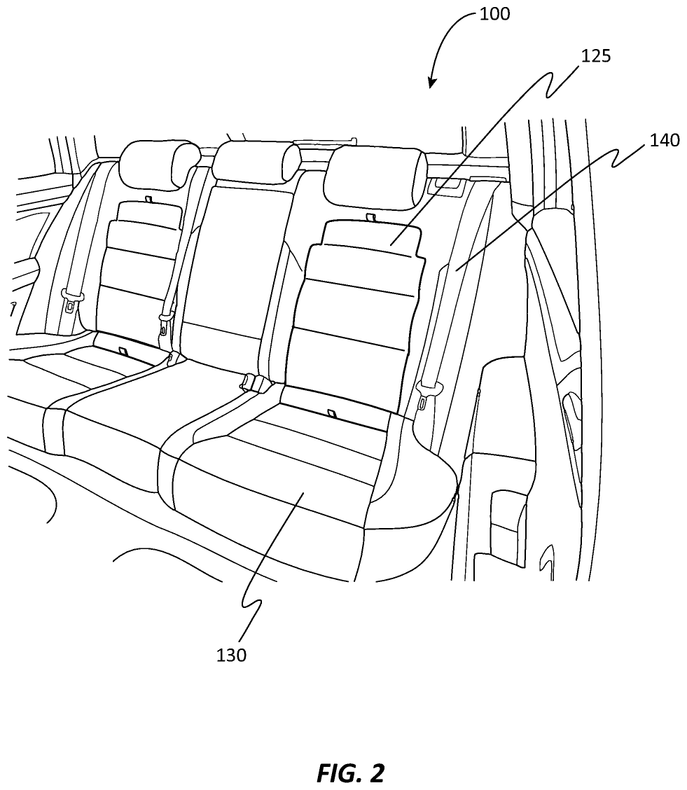

FIG. 2 is a view of an automobile seat 100 with the secondary car-seat portion 120 disposed or stored in the back portion 125.

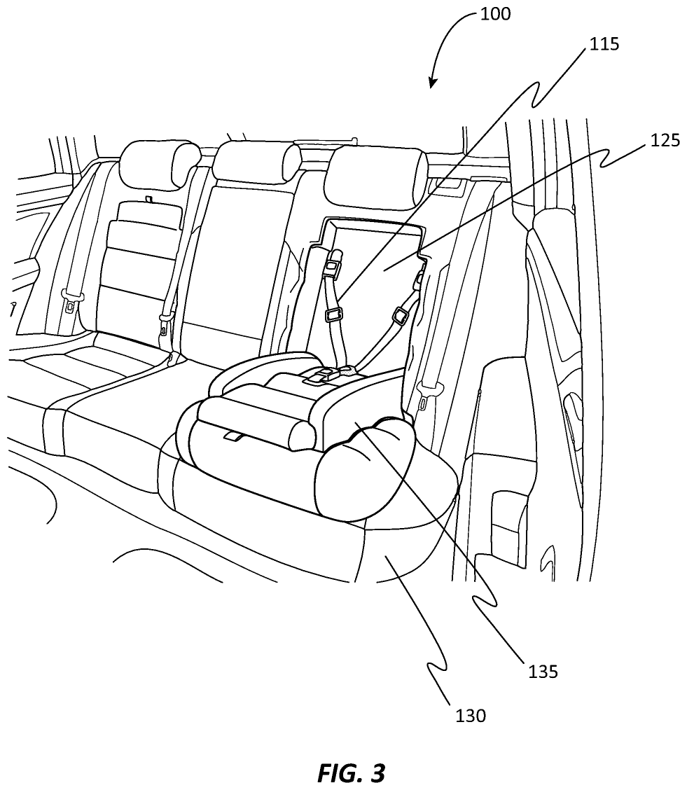

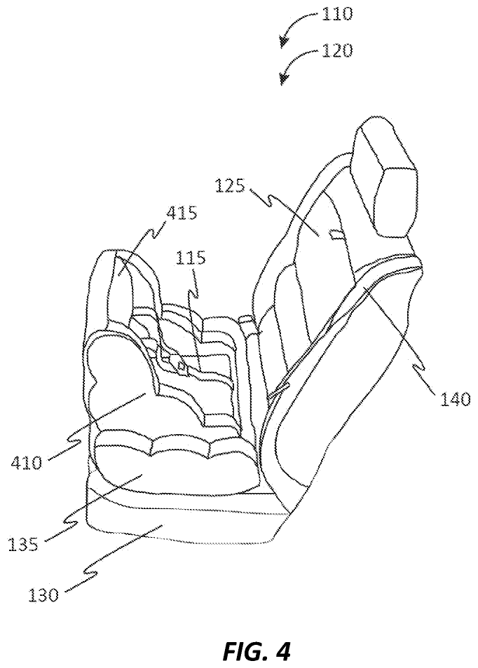

FIG. 3 shows a view of an automobile seat 100 with a secondary car-seat portion 120 deployed in a front-facing position, with a shoulder- or pelvis-restraining strap 115 and a seat belt 140 (FIG. 4) present. The shoulder- or pelvis-restraining strap 115 is relocatable; it can be moved depending on the child being transported. An infant 5 and toddler 10 can both be transported with the strap 115 since both children's sizes require restraint at the shoulders and pelvis. A larger child can be transported with the seat belt 140.

FIG. 4 is a side view of an automobile seat 100 with a secondary car-seat portion 120 in a rear-facing position showing a shoulder- or pelvis-restraining strap 115 that restrains the shoulders and pelvis. Infant width panels 410 should be wide enough to accommodate an infant 5 comfortably (i.e., the infant 5 should not be spilling out of the infant width panels 410) and for the shoulder- or pelvis-restraining strap 115 to secure the infant 5. The location of the shoulder- or pelvis-restraining strap 115 for an infant 5 differs from that for a toddler 10, which is the reason why the shoulder- or pelvis-restraining strap 115 is relocatable. An infant headrest 415 should be high enough to support the head of an infant 5. The head of an infant 5 should not extend above the headrest 415. As seen in FIG. 1A, the head of infant 5 is stabilized and not free to flop around. The distance between the headrest 415 and the back portion 125 should be large enough for an infant 5 to stretch its arms and legs without difficulty.

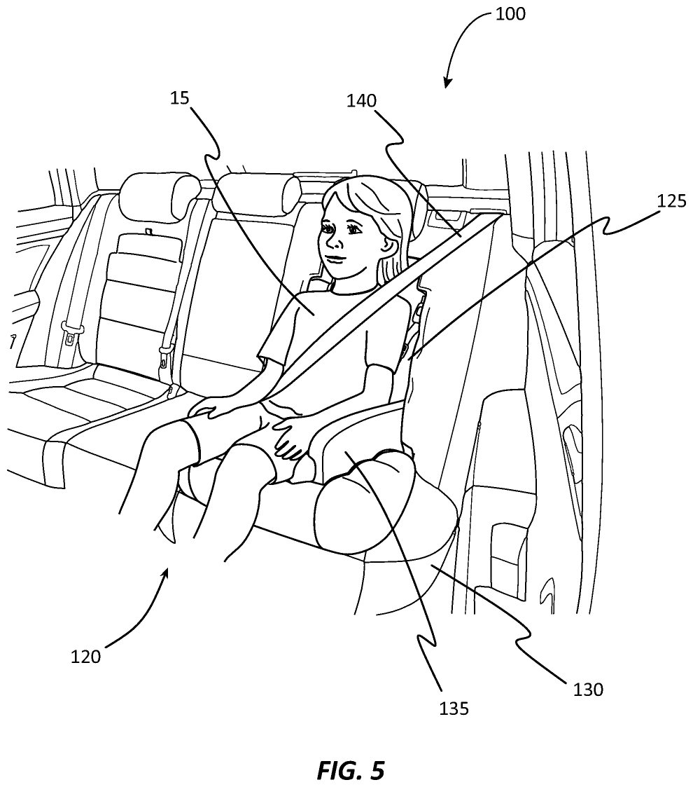

FIG. 5 views a big child 15 in a booster position, restrained by a seat belt 140. In the booster position, the big child 15 is facing toward the front of the car. The secondary car-seat portion 120 is deployed from the back portion 125 and is returned to the back portion 125 for stowing purposes. In contrast to toddler 10, the big child 15 can be retrained with a seat belt 140; restraint of the shoulders and pelvis is not as critical for the big child 15 because seat belt 140 can adequately restrain child 15. The seat bottom 135 of the secondary car-seat portion 120 is in contact with the bottom portion 130 when the secondary car-seat portion 120 is in use.

### Other Embodiments

The detailed description set-forth above is provided to aid those skilled in the art in practicing the present invention. However, the invention described and claimed herein is not limited in scope by the specific embodiments herein disclosed because these embodiments are intended to illustrate several aspects of the invention. Any equivalent embodiments are intended to be within the scope of this invention. Indeed, various modifications of the invention in addition to those shown and described herein will become apparent to those skilled in the art from the foregoing description, which does not depart from the spirit or scope of the present inventive discovery. Such modifications are also intended to fall within the scope of the appended claims.

What is claimed is:

1. An automobile seat having a bottom portion, a back portion, a seat belt, and a secondary car-seat portion having a back,
wherein
the car-seat portion is foldable among
a user rear-facing position,
a user front-facing position,
a user booster position,
and
a stowed position,
and
the secondary car-seat portion sits inside the automobile seat in the stowed position.

2. The seat of claim 1, wherein the rear-facing position has a user-contact region facing a car back end.

3. The seat of claim 2, wherein the booster position has a user-contact region facing a car front end.

4. The seat of claim 3, wherein in the front-facing position, the user-contact region faces a car front end.

5. The seat of claim 4 further comprising a shoulder- or pelvis-restraining strap.

6. The seat of claim 5 wherein, in the stowed position, the car-seat portion sits inside a front-facing portion of the back portion.

7. The seat of claim 6 wherein, in either the rear-facing position, the front-facing position, or the booster position, the car-seat portion presses into the automobile seat bottom portion.

8. The seat of claim 5 wherein the strap size is adjustable to a user size.

9. The seat of claim 8, wherein the secondary car-seat portion lacks a lap bar, a contracting piston, a padded bar restraint, or a slide assembly.

10. The seat of claim 9, wherein the car-seat portion stores inside the back portion.

11. The seat of claim 10 wherein, in either of the rear-facing position, the front-facing position, or the booster position, the car-seat portion presses into the automobile seat bottom portion.

12. The seat of claim 11 wherein, in the booster position, the seat belt restrains the user.

13. The seat of claim 1 wherein the automobile seat lacks a lap bar, a contracting piston, a padded bar restraint, or a slide assembly.

14. An automobile seat having a bottom portion, a back portion, a seat belt, and a secondary car-seat portion having a back,
wherein
the car-seat portion is foldable among
a user rear-facing position having relocatable shoulder- or pelvis-restraining strap,
a user front-facing position having relocatable shoulder- or pelvis-restraining strap,
a user booster position having relocatable shoulder- or pelvis-restraining strap,
and
a stowed position in which the car-seat portion sits inside the back portion,
in either of the rear-facing position, the front-facing position, or the booster position, the car-seat portion presses into the automobile seat bottom portion,
and
the automobile seat lacks a lap bar, a contracting piston, a padded bar restraint, or a slide assembly.

15. The seat of claim 1, wherein the car-seat portion folds forward out of the back portion.

16. The seat of claim 1 wherein the car-seat portion connects to the automobile seat between a bottom edge of the back portion and an edge of the car seat bottom.

17. The seat of claim 1 wherein, in the stowed position, the car-seat portion sits within the automobile seat.
